(19) United States
(12) Patent Application Publication
(10) Pub. No.: US 2015/0247596 A1
(43) Pub. Date: Sep. 3, 2015

(54) APPARATUS AND METHOD FOR ASSEMBLING A PIPING SYSTEM

(71) Applicant: Maxwell Clive Crawford, Denver, NC (US)

(72) Inventor: Maxwell Clive Crawford, Denver, NC (US)

(21) Appl. No.: 14/194,179

(22) Filed: Feb. 28, 2014

(51) Int. Cl. F16L 27/08; F16L 15/00

(52) U.S. Cl. CPC F16L 27/0849; F16L 15/00; F16L 27/08

(57) ABSTRACT

An apparatus and method for assembling a piping system is disclosed. The apparatus is configured to interconnect individual pieces of piping to form a piping system and includes a conduit section having a first attachment end configured to connect the conduit section to a first pipe of the piping system. The apparatus further includes a spherical shell section connected to the conduit section. The spherical shell section includes at least one attachment point formed therein to connect a second pipe to the spherical shell section at a pre-determined angle relative to the first pipe, thereby securing the first pipe in flowing communication with the second pipe

### BACKGROUND OF THE INVENTION

This application relates to an apparatus and method for assembling a piping system and, more particularly, to pipe system fittings and their method of use to allow piping systems to be precisely run at various angles.

Piping, conduit, or tubing (hereinafter, collectively referred to as piping) is used to form a piping system to run material inside of the piping system from a start point to an end point. The material may be a fluid such as oil or water, cabling, or any other material typically run through piping systems. The piping systems are assembled by inter-connecting multiple pieces of pipe with fittings. The fittings may be threaded, socket weld, or butt weld type fittings and include elbows, Tees, couplers, and other suitable types of fittings. For purposes of this application, the term weld or welding shall include adhesives in addition to the melting of materials for a secure connection.

While fittings have been used for years and have been developed to permit piping systems to be run in a variety of situations, one draw back to current fittings is that they are manufactured to a pre-set configuration standard, i.e., elbows are produced in two configurations—90 degrees and 45 degrees. While the pre-set configurations are capable of handling a majority of piping system runs, there are times when it would be very beneficial to have a fitting that allows a user to assemble the piping system at an angle that is outside of the pre-set configurations, for example, an elbow fitting that turns the piping system 32 degrees instead of 45 degrees.

With current fittings, when a non-preset configuration is desired, assemblers typically use multiple fittings to obtain the desired angle, resulting in a hodge-podge of fittings, or, in the case of flexible piping systems, they stress the piping system by flexing it to meet the angle that is desired. Accordingly, there is a need for a fitting that allows an assembler or user to easily run a piping system at any desired angle without using multiple fittings or stressing the piping system.

### BRIEF SUMMARY OF THE INVENTION

These and other shortcomings of the prior art are addressed by the present invention, which provides an apparatus configured to allow a user to precisely run a piping system without the need to use multiple fittings.

According to one aspect of the invention, an apparatus configured to interconnect individual pieces of piping to form a piping system includes a conduit section having a first attachment end configured to connect the conduit section to a first pipe of the piping system; and a spherical shell section connected to the conduit section, the spherical shell section having at least one attachment point formed therein to connect a second pipe to the spherical shell section at a pre-determined angle relative to the first pipe, thereby securing the first pipe in flowing communication with the second pipe.

According to another aspect of the invention, a method of interconnecting at least two individual pipes of a piping system includes the steps of providing an apparatus configured to interconnect at least two pieces of pipe. The apparatus includes a conduit section and a spherical shell section. The method further includes the steps of connecting a first pipe to the conduit section, determining a connection angle of a second pipe relative to the first pipe, forming a connection point in the spherical shell section at the determined connection angle, and connecting the second pipe to the connection point.

### BRIEF DESCRIPTION OF THE INVENTION

The subject matter that is regarded as the invention may be best understood by reference to the following description taken in conjunction with the accompanying drawing figures in which:

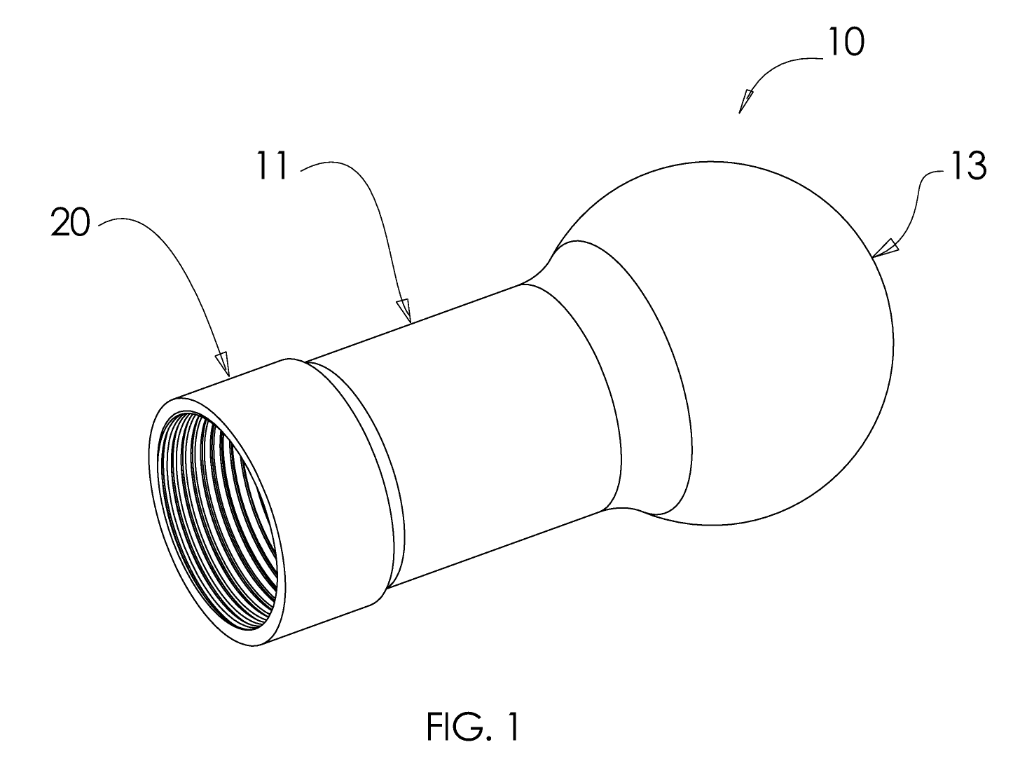

FIGS. 1-4 are a perspective views of an apparatus according to an embodiment of the invention;

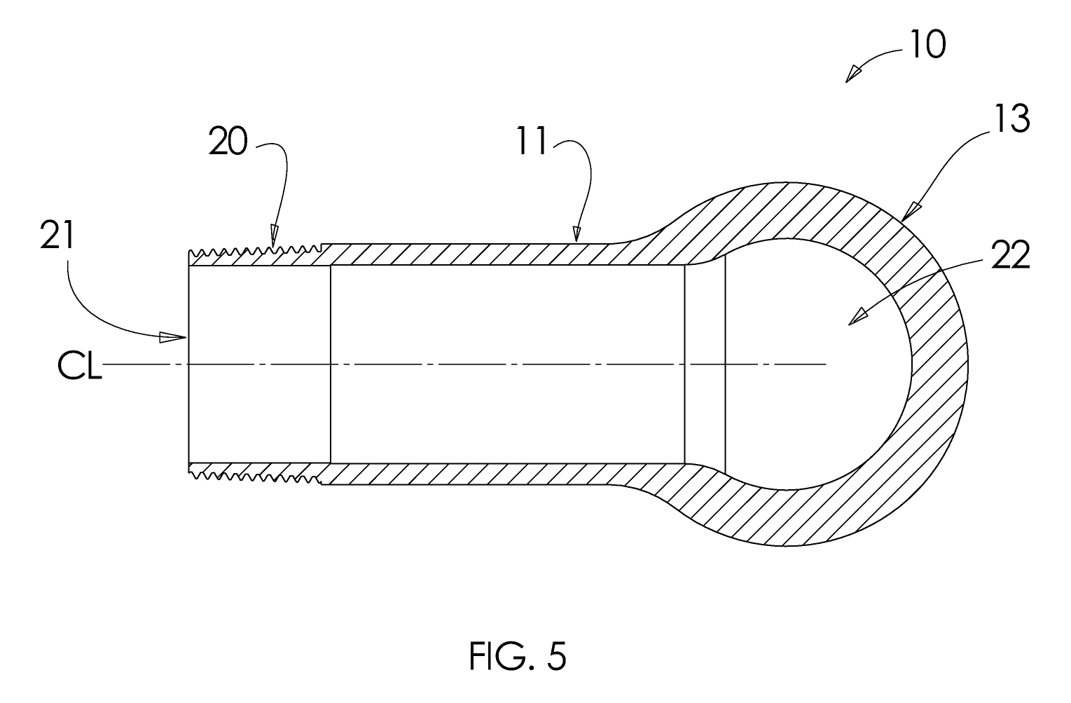

FIG. 5 is a cross-sectional view of the apparatus of FIG. 1;

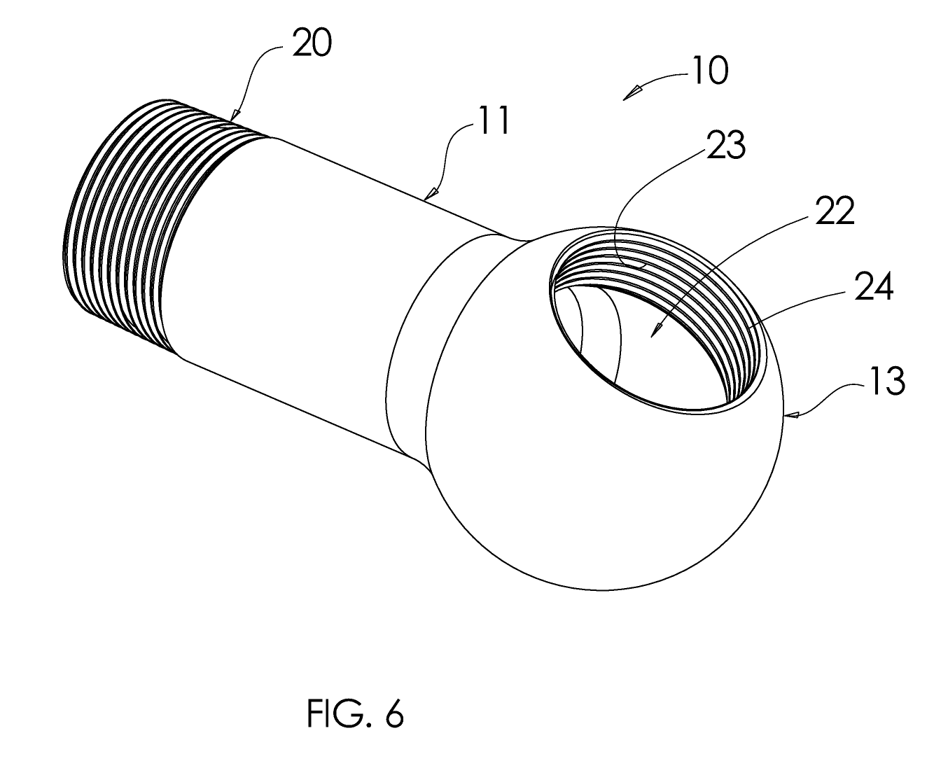

FIG. 6 shows the apparatus of FIG. 1 with an aperture formed in a spherical shell of the apparatus;

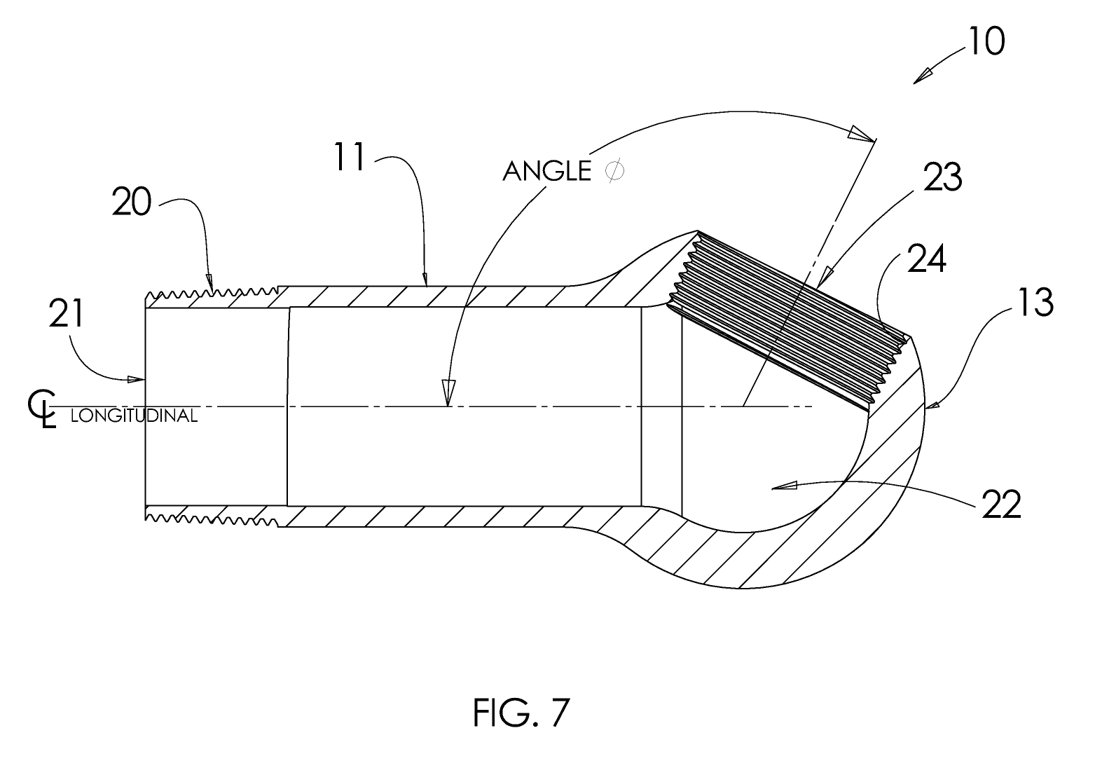

FIG. 7 is cross-sectional view of the apparatus of FIG. 6 showing an angle of the aperture with respect to a longitudinal center line axis;

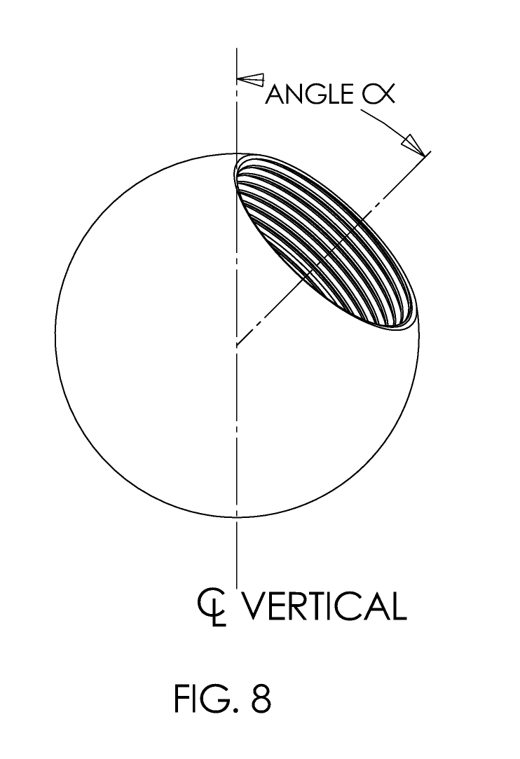

FIG. 8 shows an angle of the aperture formed in the apparatus of FIG. 6 with respect to a vertical center line axis;

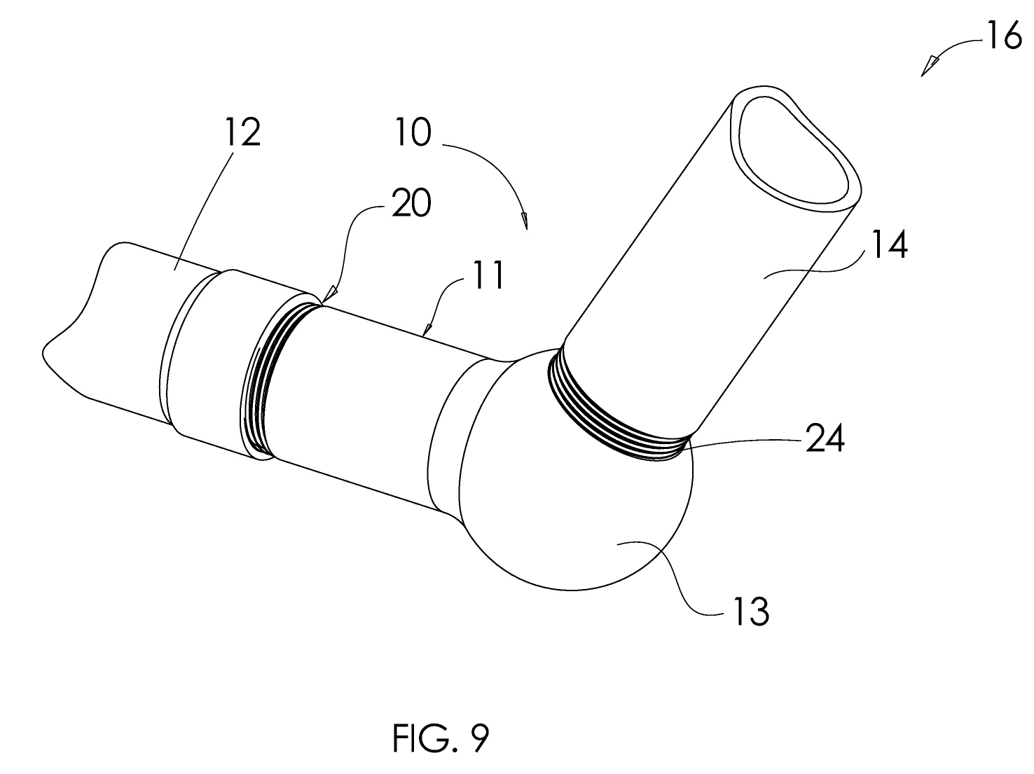

FIG. 9 shows a piping system using the apparatus of FIG. 6;

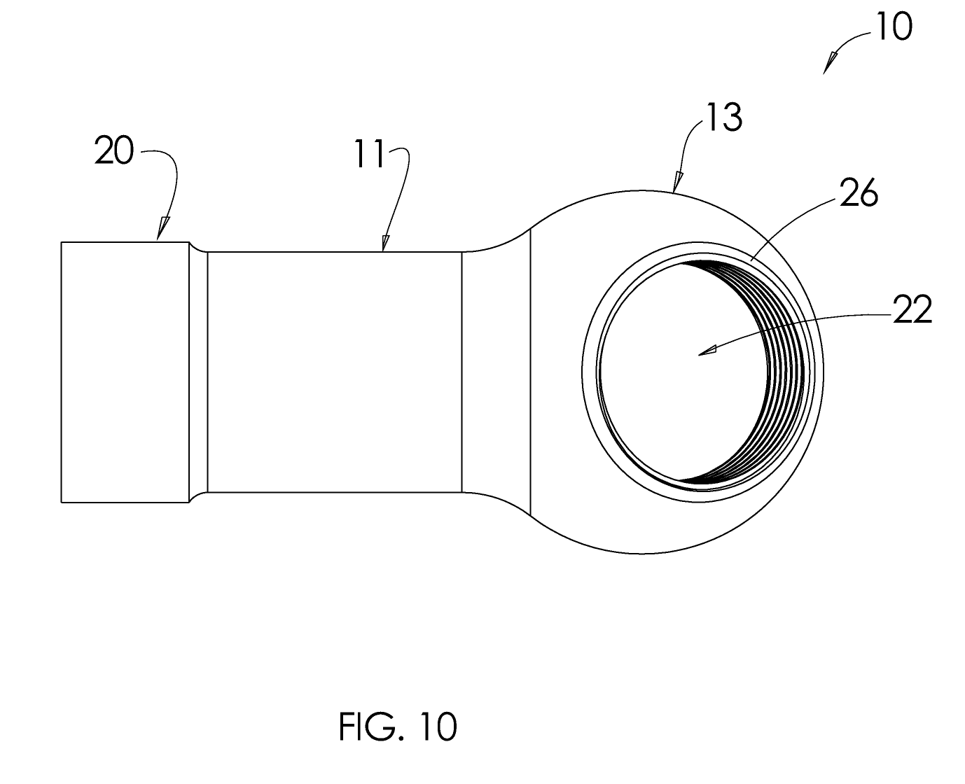

FIG. 10 shows the apparatus of FIG. 6 with an insert installed in the aperture formed therein to form an attachment point;

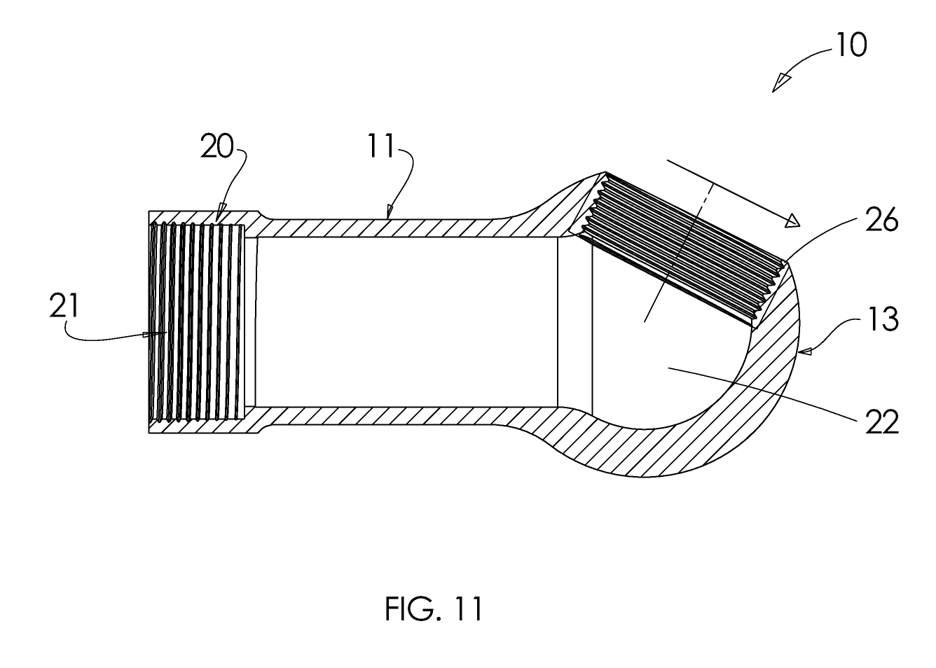

FIG. 11 is a cross-sectional view of the apparatus of FIG. 10 showing the insert;

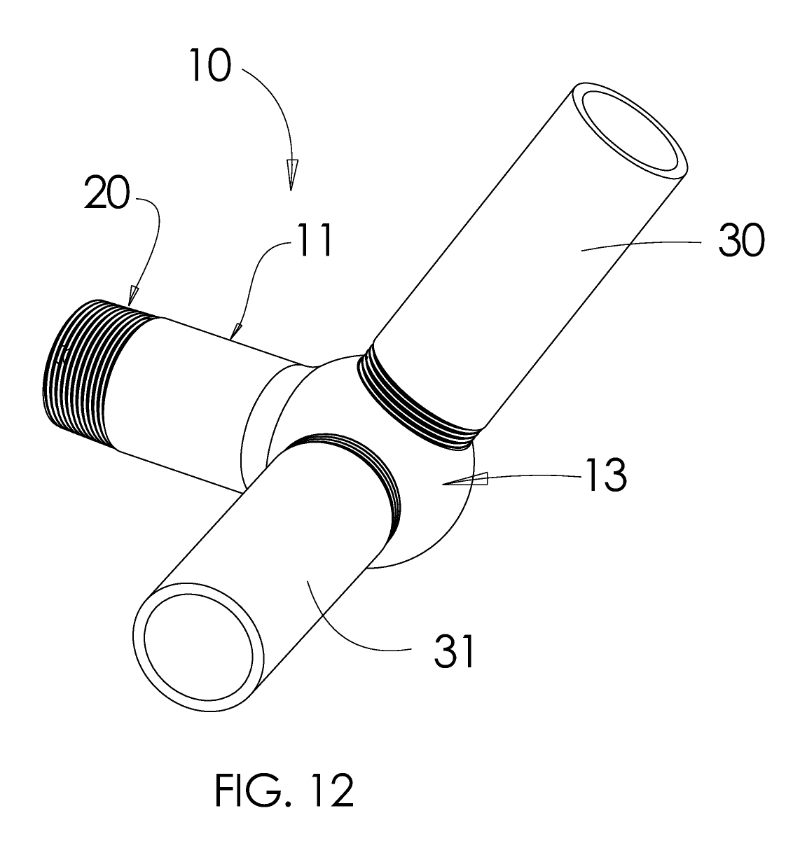

FIG. 12 shows the apparatus of FIG. 6 with multiple pipes connected to the spherical shell of the apparatus to form a piping system;

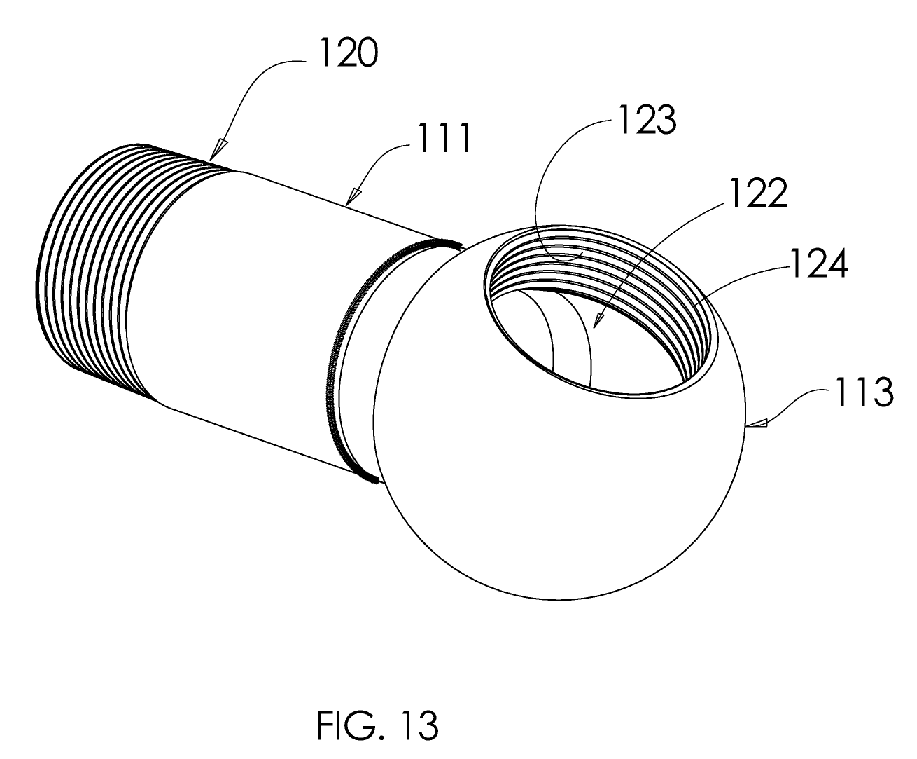

FIG. 13 is a perspective view of an apparatus according to an embodiment of the invention;

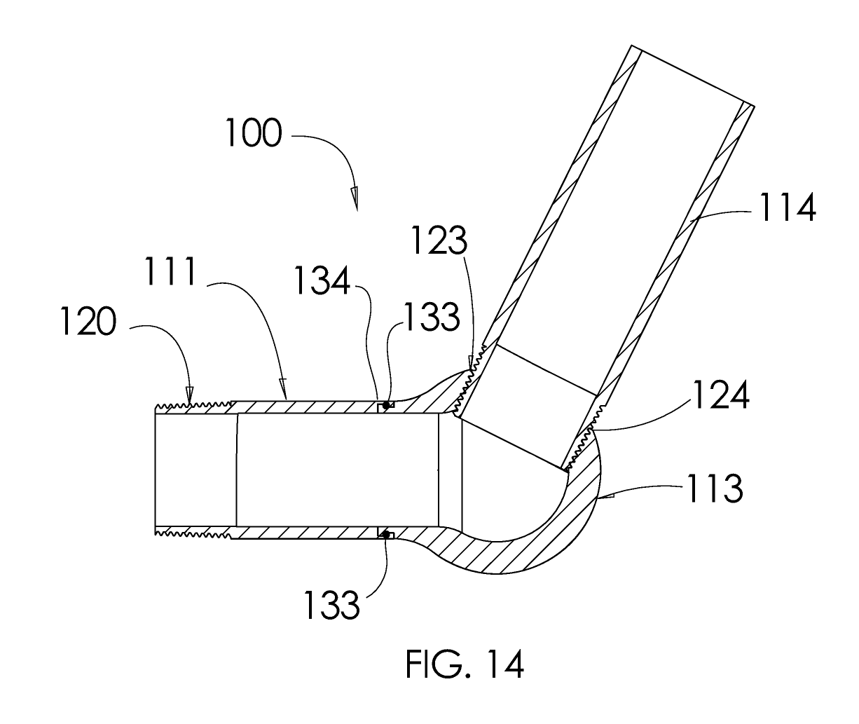

FIG. 14 is a cross-sectional view of the apparatus of FIG. 13; and

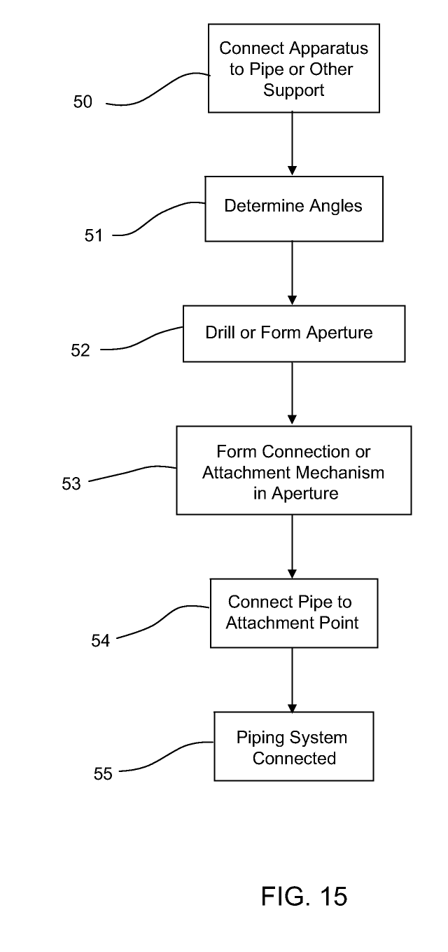

FIG. 15 is a flow diagram of a method according to an embodiment of the invention.

### DETAILED DESCRIPTION OF THE INVENTION

Referring to the drawings, an apparatus in accordance with an embodiment of the invention is illustrated in FIGS. 1-4 and shown generally at reference numeral 10. The apparatus 10 is in the form of a pipe fitting and includes a conduit section 11 for connection to a first pipe 12 and an enlarged spherical shell section 13, integrally formed with the conduit section 11, for connection to a second pipe 14 of a piping system 16 (See FIG. 9). For high pressure or high flow services or industrialized use such as oil lines, the apparatus 10 is formed of a composite material such as filament wound with fiberglass with epoxy resin. In lower pressure or lower flow services or residential use such as water services in a house or sewage services, the apparatus 10 may be formed of a Polyvinylchloride (PVC) or other suitable material.

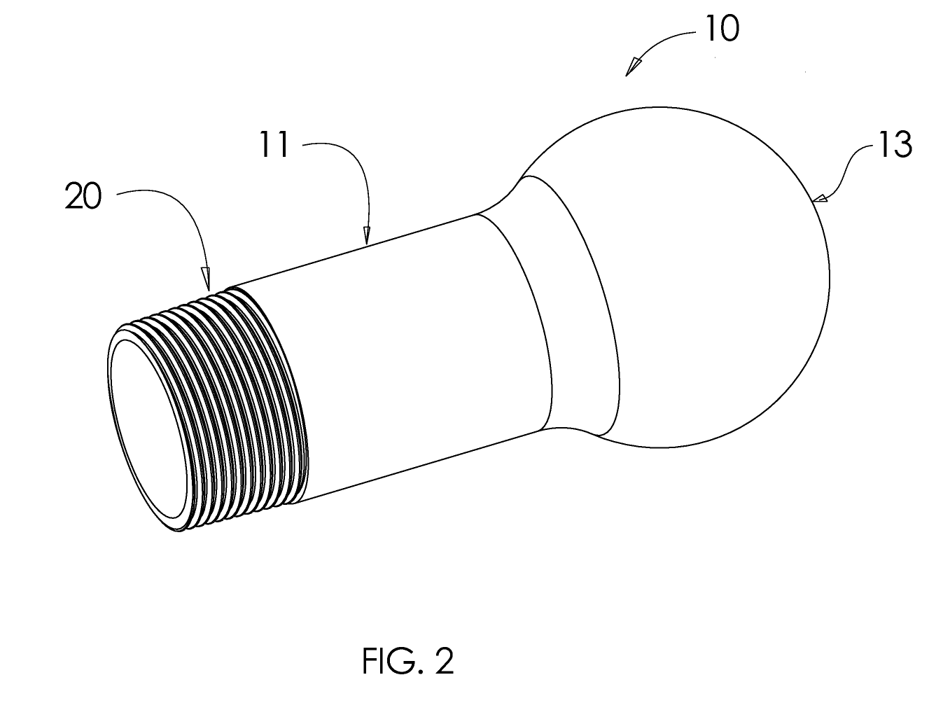

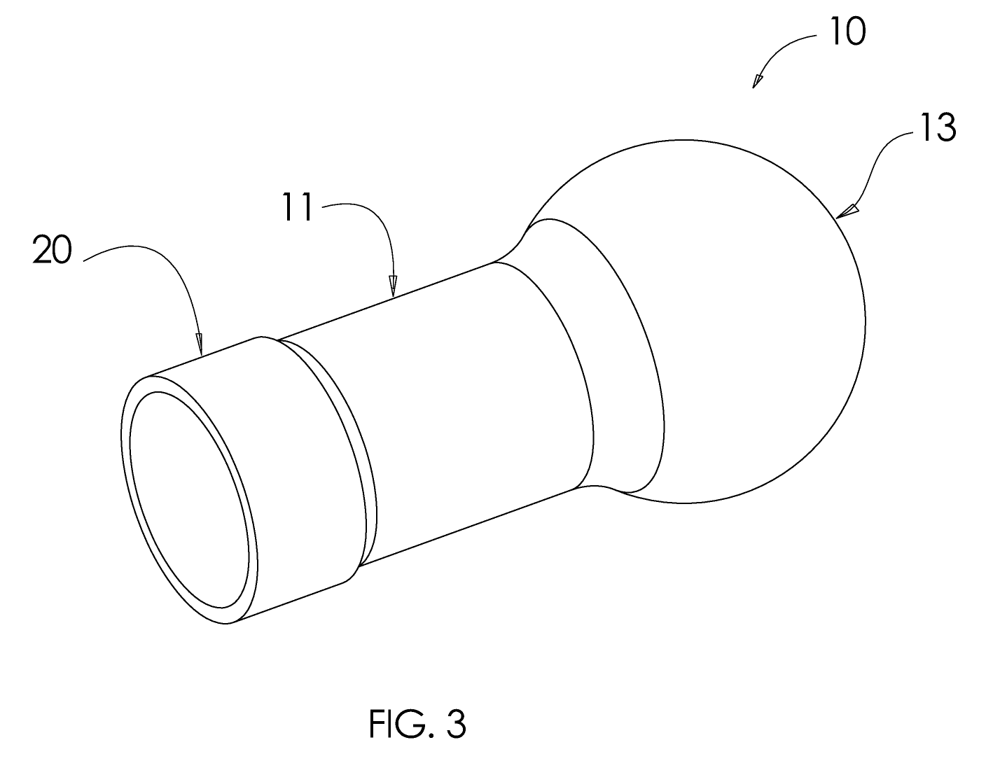

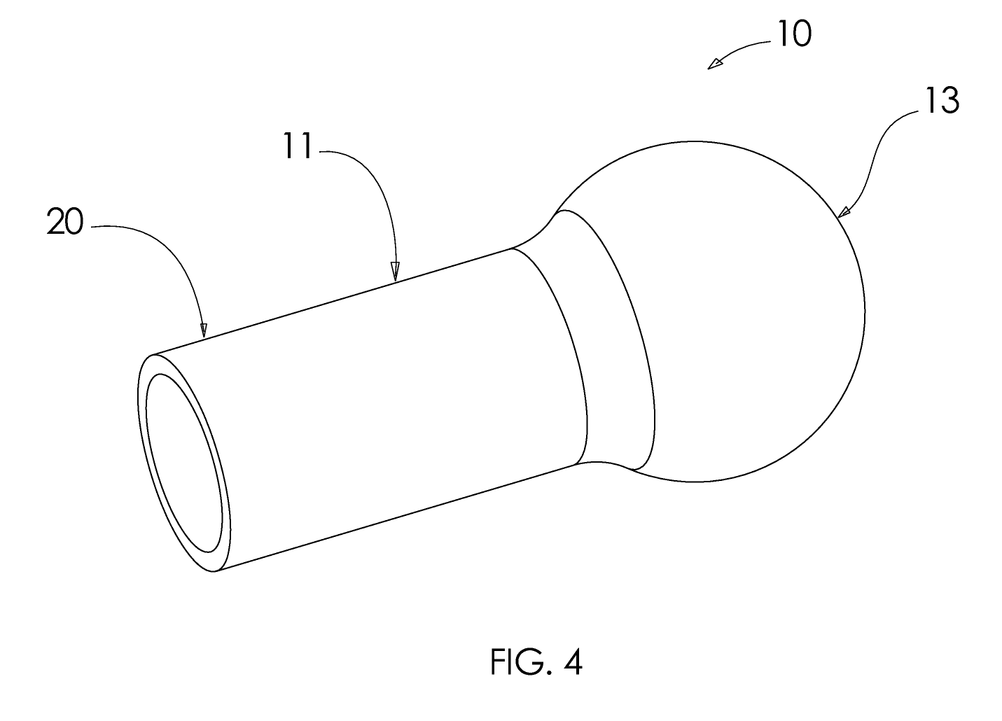

As shown, the conduit section 11 includes a first attachment end 20 configured for connection to the first pipe 12. The first attachment end 20 may be male (FIGS. 1 and 3) or female (FIGS. 2 and 4) and may be a threaded attachment (FIGS. 1 and 2) or a socket style attachment (FIGS. 3 and 4). It should be appreciated that the first attachment end 20 may be any suitable style of attachment to allow the apparatus 10 to be used in a piping system.

Referring to FIG. 5, a passageway 21 extends through the apparatus 10 from the first attachment end 20 through the conduit section 11 and into the spherical shell section 13 where a cavity 22 is formed. The passageway is configured to allow a fluid to flow through the apparatus once connected into the piping system 16.

As shown in FIGS. 6-9, the spherical shell section 13 is configured to allow the second pipe 14 to be connected to the apparatus 10 at various angles theta (θ) ranging from about forty-five (45°) degrees to three-hundred and fifteen (315°) degrees from a longitudinal center line axis of the apparatus 10. As illustrated in FIG. 7, the angle θ is approximately one-hundred and fifteen (115°) degrees. In addition, the second pipe 14 may be connected to the apparatus 10 at various angles alpha (α) ranging from zero (0°) degrees to three hundred and sixty (360°) degrees from a vertical centerline of the apparatus 10. See FIG. 8. As shown in FIG. 8, the angle α is approximately forty-five (45°) degrees. Together, the angles θ and α position the second pipe 14 at a compound angle relative to the apparatus 10. Thus, unlike a typical fitting such as a ninety (90°) degree elbow, a user is not strapped with making a pre-determined fitting work in a piping system.

In use (FIG. 15), a user connects the apparatus 10 to the first pipe 12 or to a support, Block 50, and determines the angles needed for the piping system 16, Block 51, for example, the angle θ may be one hundred and five (105) degrees and the angle α may be forty-five degrees. Once the angles are chosen, the user drills a hole or aperture 23 into the spherical shell section 13, Block 52, at the pre-determined angles to form an attachment point 24 for the second pipe 16. In the case of a threaded connection, the aperture 23 is then tapped to allow the second pipe 14 to be threaded into the spherical shell section 13, Block 53. Alternatively, a pre-configured insert 26 (threaded or socket configurations) may be secured in the aperture 23, Block 53, to allow for connection to a pipe, See FIGS. 10 and 11. The second pipe 14 may then be connected to the attachment point 24, Block 54, to form the piping system 16, Block 55. While the description above discusses drilling an aperture in the field, it should be appreciated that pre-drilled apparatuses 10 may also be supplied to eliminate field drilling.

Referring to FIG. 12, another benefit of the enlarged spherical shell section 13 is that it provides an increased surface area to allow for more than one connection. As shown, the spherical shell section 13 allows a user to drill more than one aperture for connection to more than one pipe. This is particularly useful when a user needs to split a single pipe run into two or more pipe runs running at various angles. For example, a first pipe 30 might extend at an angle θ of one hundred and five (105) degrees from the longitudinal center line axis of apparatus 10 and the second pipe 31 might also extend at an angle θ of one hundred and five (105) degrees from the longitudinal center line axis of apparatus 10. In addition, the first pipe 30 might need to be positioned at an angle α of forty five (45) degrees from the vertical center line axis and the second pipe 31 might need to be positioned at an angle α of three hundred and fifteen (315) degrees from the vertical center line axis. As can be seen, the spherical shell section 13 allows a user multiple configurations.

An apparatus according to another aspect of the invention is illustrated in FIGS. 13 and 14 and shown generally at reference numeral 100. Like apparatus 10, apparatus 100 includes a conduit section 111, an enlarged spherical shell section 113, an attachment end 120, an aperture 123 and attachment point 124, a passageway 121, and a cavity 122. Unlike apparatus 10, apparatus 100 is of a two piece construction. As shown, the spherical shell section 113 is configured to rotate with respect to the conduit section 111. By allowing the spherical shell section 113 to rotate, the aperture 123 can self-align with the pipe 114 along the vertical center line axis to help eliminate any stresses on the pipe 114 caused by improper alignment. A seal 133 is positioned between the conduit section 111 and the spherical shell section 13 at a connection point 134 to prevent leakage therebetween. The seal may be of an O-ring construction or any other suitable type of seal construction.

The foregoing has described an apparatus and method for assembling a piping system. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

I claim:

1. An apparatus configured to interconnect individual pieces of piping to form a piping system, comprising:
(a) a conduit section having a first attachment end configured to connect the conduit section to a first pipe of the piping system; and
(b) a spherical shell section connected to the conduit section, the spherical shell section having at least one attachment point formed therein to connect a second pipe to the spherical shell section at a pre-determined angle relative to the first pipe, thereby securing the first pipe in flowing communication with the second pipe.

2. The apparatus according to claim 1, wherein the apparatus is formed of a composite material.

3. The apparatus according to claim 2, wherein the composite material is a filament wound with fiberglass with epoxy resin.

4. The apparatus according to claim 1, wherein the first attachment end has a connection configuration selected from the group consisting of threaded and socket configurations.

5. The apparatus according to claim 1, wherein the conduit section and spherical shell section are integrally formed.

6. The apparatus according to claim 1, wherein the spherical shell section is rotatably connected to the conduit section to allow the spherical shell section to rotate relative to the conduit section.

7. The apparatus according to claim 6, further including seals between the conduit section and spherical shell section to prevent leaks therebetween.

8. A method of interconnecting at least two individual pipes of a piping system, comprising the steps of:
(a) providing an apparatus configured to interconnect at least two pieces of pipe, the apparatus including:
(i) a conduit section; and
(ii) a spherical shell section;
(b) connecting a first pipe to the conduit section;
(c) determining a connection angle of a second pipe relative to the first pipe;
(d) forming a connection point in the spherical shell section at the determined connection angle; and
(e) connecting the second pipe to the connection point.

9. The method according to claim 8, wherein the step of forming a connection point includes the steps of:
(a) drilling a hole into the spherical shell section; and
(b) tapping the hole to provide a threaded connection.

10. The method according to claim 8, wherein the step of forming a connection point includes the steps of:
(a) drilling a hole into the spherical shell section; and
(b) forming a pocket to provide a socket connection.

11. The method according to claim 8, wherein the step of forming a connection point includes the steps of:
(a) drilling a hole into the spherical shell section; and
(b) securing an insert in the hole to provide a threaded or socket connection.
